(19) United States
(12) Patent Application Publication
(10) Pub. No.: US 2025/0383019 A1
(43) Pub. Date: Dec. 18, 2025

(54) ROBUST SEALING ARRANGEMENT

(71) Applicant: CALDERA ENGINEERING, L.C., Provo, UT (US)

(72) Inventors: JEFFREY C. ROBISON, Provo, UT (US); DARRYL DEPEW, Provo, UT (US); JOSEPH PRINCE, Provo, UT (US); MARC RABY, Provo, UT (US); NICHOLAS WALLACE, Provo, UT (US); IAN DAVIS, Provo, UT (US); CHAUNCY RIPPLE, Provo, UT (US)

(73) Assignee: CALDERA ENGINEERING, L.C., Provo, UT (US)

(21) Appl. No.: 19/234,129

(22) Filed: Jun. 10, 2025

Related U.S. Application Data
(60) Provisional application No. 63/659,073, filed on Jun. 12, 2024.

(51) Int. Cl. F16K 1/42; F16K 25/04

(52) U.S. Cl. CPC F16K 1/42; F16K 25/04

(57) ABSTRACT

A valve seat assembly and a plug head assembly is provided herein. The valve seat may include a set of ceramic valve seat liners. The plug head assembly may include a set of ceramic plug head liners.

### CROSS-REFERENCE TO RELATED APPLICATIONS

This application claims priority to, and the benefit of, U.S. Provisional Patent Application No. 63/659,073, filed Jun. 12, 2024 and titled “ROBUST SEALING ARRANGEMENT,” which is incorporated by reference herein in its entirety for all purposes.

### BACKGROUND

In various industrial processes, such as in mineral processing, solids and liquids may be conveyed from one vessel to another under high temperatures and high pressures. Flow control may be desired between two vessels so that the flow may regulated.

### SUMMARY

In various embodiments, a valve seat is provided comprising a valve seat housing coaxially disposed with a seat liner assembly the seat liner assembly comprising a first valve seat liner assembly and a second valve seat liner assembly, the first valve seat liner assembly disposed coaxially to the second first valve seat liner assembly, wherein the first valve seat liner assembly comprises a first ceramic liner and a first compliant sleeve, wherein the second valve seat liner assembly comprises a second ceramic liner and a second compliant sleeve.

In various embodiments, a plug head assembly is provided comprising a stem coupled to a retainer, the retained comprising an annulus geometry, a plug head liner assembly disposed coaxial to the retainer, the plug head liner assembly comprising a first plug head liner assembly and a second plug head liner assembly, the first plug head liner assembly disposed coaxially to the second first plug head liner assembly, wherein the first plug head liner assembly comprises a first ceramic liner and a first compliant sleeve, wherein the second plug head liner assembly comprises a second ceramic liner and a second compliant sleeve.

### BRIEF DESCRIPTION OF THE DRAWINGS

Various embodiments are particularly pointed out and distinctly claimed in the concluding portion of the specification. Below is a summary of the drawing figures, wherein like numerals denote like elements and wherein:

FIG. 1 illustrates an industrial process having a control valve in accordance with various embodiments;

FIG. 2 illustrates a cross section view of a valve seat and flat plug head configuration in accordance with various embodiments;

FIG. 3 illustrates a cross section view of a valve seat and parabolic plug head configuration in accordance with various embodiments;

FIG. 4 illustrates an exploded cross section view of a valve seat assembly of FIG. 3, in accordance with various embodiments;

FIG. 5 illustrates a cross section view of a plug head assembly of FIG. 3, in accordance with various embodiments;

### DETAILED DESCRIPTION

The detailed description of exemplary embodiments herein makes reference to the accompanying drawings, which show exemplary embodiments by way of illustration and its best mode. While these exemplary embodiments are described in sufficient detail to enable those skilled in the art to practice the inventions, it should be understood that other embodiments may be realized and that logical, chemical and mechanical changes may be made without departing from the spirit and scope of the inventions. Thus, the detailed description herein is presented for purposes of illustration only and not of limitation. For example, the steps recited in any of the method or process descriptions may be executed in any order and are not necessarily limited to the order presented. Moreover, many of the functions or steps may be outsourced to or performed by one or more third parties. Furthermore, any reference to singular includes plural embodiments, and any reference to more than one component or step may include a singular embodiment or step. Also, any reference to attached, fixed, connected or the like may include permanent, removable, temporary, partial, full and/or any other possible attachment option.

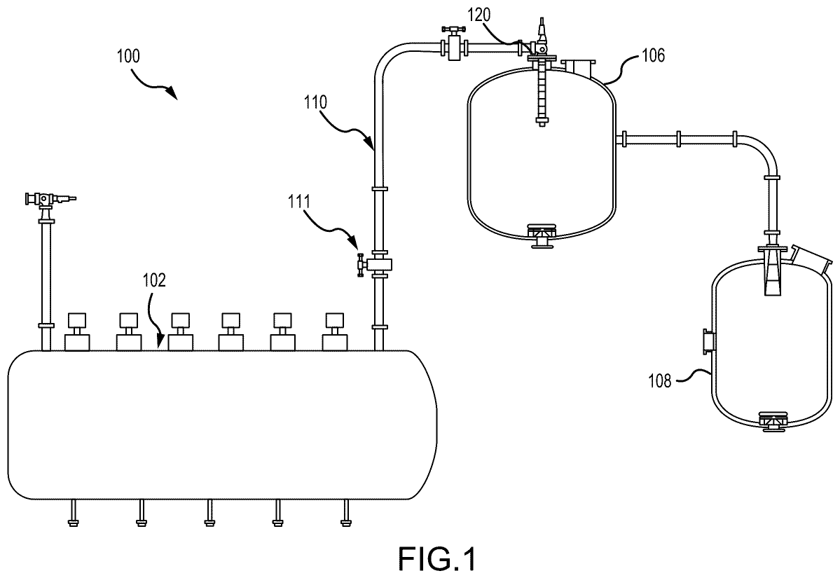

A throttling or control valve may operate to regulate the flow of a fluid or slurry in a conduit. For example, with reference to FIG. 1, ore processing system 100 is illustrated. Ore processing system 100 may be used in connection with high pressure acid leaching (“HPAL”), pressure oxidation (“POX”) or any other mining or industrial applications where a solvent is mixed with material containing one or more metals and subjected, for example, to at least one of elevated temperatures or pressures.

A mixture of solids, liquids, and/or gasses may be referred to as slurry, may be subjected to high temperatures and/or high pressures in autoclave 102. For example, ore may be mixed with strong acids (e.g. H₂SO₄) or strong bases (e.g., NaOH or NH₃) and may be subjected to temperatures of from 80° C. to 300° C. or greater and total pressures of from about 10 psi (˜68 kPa) to 900 psi (˜6,205 kPa). The slurry may have a pH below 1 to 4 (in an acidic application) or between about 10 to 14 (in a basic application). A throttling valve, such as a control valve 120, may be positioned between autoclave 102 and a high pressure flash tank 106, and may act to control the flow between the two components of ore processing system 100. Low pressure flash tank 108 is also illustrated for reference. Control valve 120 may be paired with isolation valve 111. Isolation valve 111 may be a ball valve, plug valve, or any other suitable valve.

Autoclave 102 may be sized according to industrial need, but is in various embodiments greater than 200 m³. The size of discharge line 110 may also vary, but is in various embodiments greater than 50 mm in diameter. Control valve 120 may comprise an angle-type valve.

In other embodiments, control valve 120 can comprise a non-isolation valve, wherein control valve 120 is used to reduce or regulate pressure and/or flow. For example, control valve 120 can comprise a flash letdown valve, or a level control valve, among other types of valves.

In operation, control valve 120 may be actuated to a closed position to fluidly isolate flash tank 106 from autoclave 102. In response to actuation to an open position, control valve 120 may experience slurry flow at high velocities, temperatures and pressures as slurry flows from autoclave 102 to high pressure flash tank 106. Control valve 120 may thus experience corrosive and erosive conditions, combined with flow velocities approaching or exceeding the speed of sound, for the fluid at process conditions, for extended periods of time.

The intended material flowing through valve seat assembly, and the velocities at which such material is intended to flow, is important in valve design. In various embodiments, a slurry comprising a solid phase, liquid phase, and gas phase is intended to flow through valve seat assemblies. According to compressible flow theory and the thermodynamics of a multiphase system, the flow at the throat is choked and flowing at the local speed of sound, according to various embodiments. As the area expands, the velocity increases and the fluid density decreases.

Plug head liner and valve seat liners may be comprised of ceramic materials, as described further below, that are particularly suited for use in corrosive and erosive environments. However, ceramics may crack over repeated use and/or misuse and/or use without appropriate maintenance and inspection. Once cracking develops, it is difficult to mitigate without replacement of the liner, which may delay production processes.

Accordingly, more robust solutions to crack mitigation are desirable in the art. Disclosed herein, in various embodiments, are valve seat liner and plug head liner arrangements that include concentric, coaxial, or otherwise nested design. By nesting or otherwise arranging separate ceramic liners in concentric, coaxial, or otherwise layered arrangements, should cracking develop in one liner and cause that liner to fail, the other liner(s) may still provide appropriate sealing and/or control. In various embodiments, any one of the concentric liners is capable of providing sealing by itself.

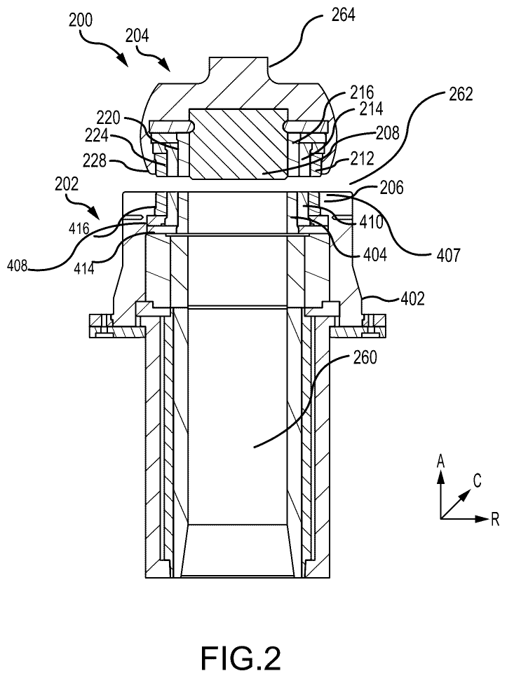

With reference to FIG. 2, a valve seat and flat plug head configuration 200 is shown in cross section. Axial-Radial-Circumferential (A-R-C) axes are shown for convenience in this and other Figures. It should be noted that a first component shown displaced in a positive axial direction with respect to second component may be referred to as distal to the second component. Valve seat and flat plug head configuration 200 may be used in a variety of valve configurations, including in control valve 120 coupled to a flash tank 106, among others.

Valve seat and flat plug head configuration 200 allows fluid communication between valve space 262 into tube volume 260.

Valve seat and flat plug head configuration 200 comprises valve seat 202 and plug head assembly 204. A plug head assembly 204 may be configured to interface with valve seat liner assembly 206 to regulate fluid flow from valve space 262 through valve seat 202 and, more specifically, through valve seat liner assembly 206.

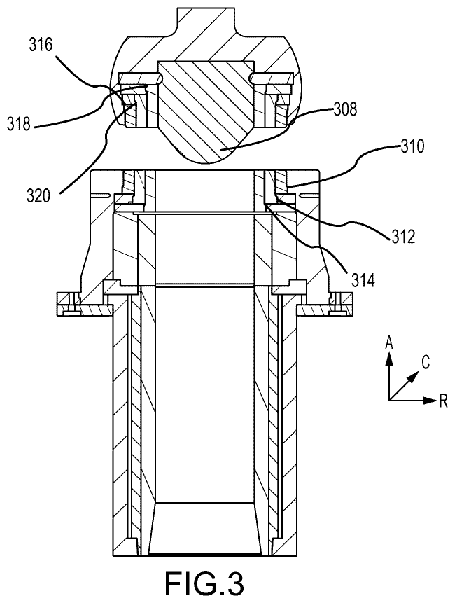

In various embodiments, the plug head assembly 204 may comprise a plug head 208 that comprises a ceramic material. Ceramics are especially well suited to high erosion applications. The plug head may have a varying geometry. For example, the geometry may be spherical, parabolic, flat, or any other suitable geometric configuration. Plug head 208 has a flat geometry, characterized by the flat surface that interacts with valve seat 202. With momentary reference to FIG. 3, plug head 308 is a parabolic geometry, characterized by the parabolic surface that interacts with valve seat 202. It is noted that FIG. 3 is identical to FIG. 2 except for the parabolic geometry of the plug head 308. There may further be a translating shaft 264 coupled to the plug head. In various embodiments, the plug head 208 can comprise one or more metals, such as, for example, various steel alloys, stainless steel, titanium, ceramics such as silicon carbide (SiC), boron carbide (B₄C), tungsten carbide (WC), and zirconia (ZrO₂), and nickel chromium alloys, such as an austenitic nickel-chromium alloy such as the austenitic nickel-chromium alloy sold under the trademark INCONEL. Nickel chromium alloys may be well suited to high temperature environments.

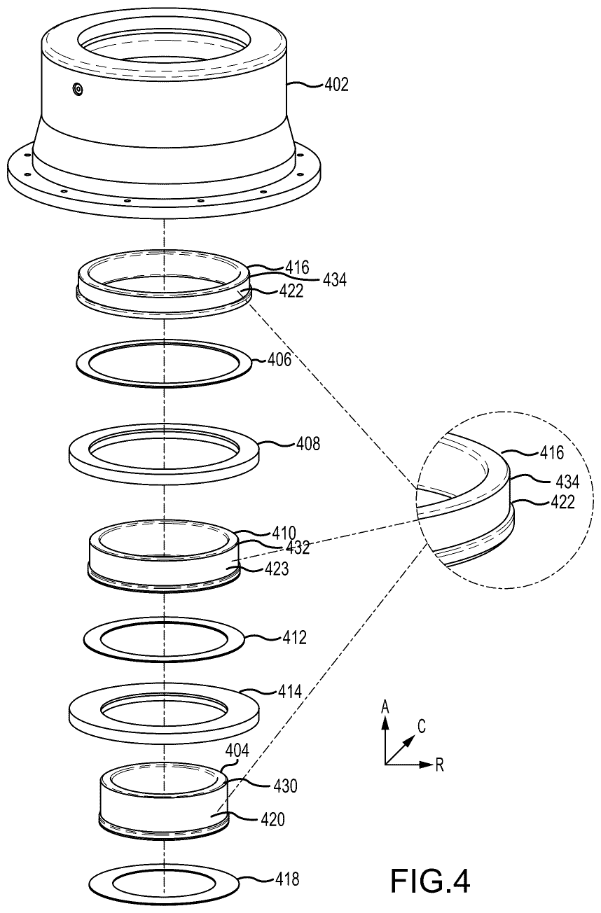

With added reference to FIG. 4, in various embodiments, valve seat liner assembly 206 comprises one or more valve seat liner ring assemblies 407, such as valve seat liner assembly 404, 410 and 416. Each of valve seat liner assembly 404, 410 and 416 comprises a valve seat liner and a compliant sleeve. In this regard, valve seat liner assembly 404 comprises valve seat liner 430 and compliant sleeve 420, valve seat liner assembly 410 comprises valve seat liner 432 and compliant sleeve 423, valve seat liner assembly 416 comprises valve seat liner 434 and compliant sleeve 422.

Valve seat liners 430, 432, 434 can comprise one or more ceramics such as silicon carbide (SiC), boron carbide (B₄C), tungsten carbide (WC), and zirconia (ZrO₂). Valve seat liners 432, 434, 430 are generally cylindrical in geometry, having a constant inner diameter (ID), though the inner diameter may taper from axial end to axial end in various embodiments. Valve seat liners 430, 432, 434 further include a proximal lip or flange about the outer circumference of valve seat liners 430, 432, 434. For example, the proximal portion of the outer diameter of valve seat liners 430, 432, 434 may radially protrude. This proximal flange may have a variety of cross sectional profiles, including rounded, square, “bull nose,” or any other suitable geometry.

Compliant sleeves 420, 423, and 422 may comprise rubber, silicone, synthetic rubbers, polytetrafluoroethylene (PTFE), glass filled PTFE, expanded PTFE, and other similar materials. Expanded PTFE is distinguished from PTFE in that expanded PTFE is microporous and thus has different physical properties than PTFE. Compliant sleeves 420, 423, and 422 can comprise rigid or semi-rigid PTFE. In various embodiments, compliant sleeves 420, 423, and 422 comprises carbon filled PTFE. Carbon filled PTFE may comprise a mixture of PTFE and a carbon form, for example, carbon powder. Carbon filled PTFE may comprise from 0.2% carbon powder to 40% carbon powder by weight, with the balance of the weight being PTFE. Carbon filled PTFE may comprise PTFE and graphite. Compliant sleeves 420, 423, and 422 may thus be elastically deformable.

In various embodiments, a valve seat liner is surrounded at least partially about the outer circumferential surface with a compliant sleeve. The compliant sleeve may cover at least a portion of the outer surface of the outer circumference of the valve seat liner and may extend in an axial direction. In various embodiments, the compliant sleeve may extend the entirety of the axial length of the valve seat liner, though in various embodiments, the compliant sleeve may extend in an axial direction to the outer circumferential flange of the valve seat liner. In this manner, the outer circumferential flange of the valve seat liner may not be surrounded by the compliant sleeve.

With continued reference to FIG. 4, retention rings 408 and 414 may comprise various steel alloys, stainless steel, titanium, titanium alloys, and nickel chromium alloys, such as an austenitic nickel-chromium alloy such as the austenitic nickel-chromium alloy sold under the trademark INCONEL. Retention rings 408 and 414 support valve seat liner assembly 404 and 410, respectively. Retention rings 408 and 414 may be coupled to valve seat housing 402 such that retention rings 408 and 414 cannot move relative to valve seat housing 402. In this manner, retention rings 408 and 414 may contact the outer diameter of valve seat liner assemblies 404 and 410. More specifically, retention rings 408 and 414 may contact the flanged portions of valve seat liner 432 and 434. Retention rings 408 and 414 may have a counterbore on the inner diameter such that a portion of retention rings 408 and 414 may radially extend to interface with flanged portions of valve seat liner 432 and 434. This configuration acts to axially retain valve seat liner assemblies 404 and 410. Valve seat liner assembly 416 may have a similar interaction with an inner diameter feature of valve seat housing 402. In this manner, valve seat housing 402 may have an area of different radial thickness that interfaces with the flanged portions of valve seat liner 430, thus acting to axially retain valve seat liner assemblies 416 with respect to valve seat housing 402.

With momentary reference to FIG. 3, the coupling of retention rings 408 and 414 and valve seat housing 402 with valve seat liners 432, 434, 430 is shown by interfaces 310, 312, and 314. Interfaces 310, 312, and 314 comprise the outer diameter flanged feature of valve seat liners 432, 434, 430 contacting a counterbore or other radially recessed feature of retention rings 408 and 414 and valve seat housing 402. In this manner, interfaces 310, 312, and 314 provide contact area surfaces for axial retention.

With continued reference to FIG. 4, gaskets 406, 412, and 418 may comprise rubber, silicone, synthetic rubbers, polytetrafluoroethylene (PTFE), glass filled PTFE, expanded PTFE, and other similar materials. Gaskets 406, 412, and 418 can comprise rigid or semi-rigid PTFE. Gaskets 406, 412, and 418 are interspersed in the assembly to axially support valve seat liner assembly 404, 410 and 416. In this manner, expansion of gaskets 406, 412, and 418 impart an axial force onto valve seat liner assembly 404, 410 and 416.

Accordingly, during operation, the metallic material of retention rings 408 and 414 and valve seat housing 402 can linearly expand at a different rate and magnitude than the ceramic material of valve seat liner 432, 434, 430. In general, metals have higher coefficients of thermal expansion than ceramics, creating a difference in the overall expansion of valve seat liner 432, 434, 430 (which linearly expands relatively less) and retention rings 408 and 414 and valve seat housing 402 (which linearly expands relatively more). For example, INCONEL alloys can range in coefficients of thermal expansion from approximately 13*10⁻⁶ mm/mm/° C. to approximately 16*10⁻⁶ mm/mm/° C., and fine ceramics can range in coefficients of thermal expansion from approximately 2*10⁻⁶ mm/mm/° C. to approximately 11*10⁻⁶ mm/mm/° C. Accordingly, the greater degree of linear expansion in the metal material of retention rings 408 and 414 and valve seat housing 402 may produce a change in the load on valve seat liner 432, 434, 430, if valve seat liner 432, 434, 430 and retention rings 408 and 414 and valve seat housing 402 were in respective, direct contact. By employing compliant sleeves 420, 422, 423 and gaskets 406, 412, and 418 comprised of a compliant material with a higher CTE, such as PTFE and/or carbon filled PTFE as described herein, axial loads may be mitigated. In addition, ceramic materials, such as those that may be used in valve seat liners 432, 434, 430, may be relatively resistant to compression loads.

As described and illustrated, valve seat liner assemblies 404, 410 and 416 are concentric (coaxial) or substantially concentric, where substantially in this context only means+/−8% of the inner diameter length of at least one of valve seat liner assemblies 404, 410 and 416. Moreover, compliant sleeves 420, 422, 423 and gaskets 406, 412, and 418 ensure that valve seat liners 432, 434, 430 have no direct, surface to surface contact or minimal direct, surface to surface contact. In this manner, forces (such as impulse forces from high speed fluid flow of corrosive and erosive media and/or media that is of mixed solid and liquid phases) exerted on one of valve seat liners 432, 434, 430 are not directly imparted to the other valve seat liners and may be in part mitigated by the presence of compliant sleeves 420, 422, 423 and gaskets 406, 412, and 418. Accordingly, should a crack develop in one of valve seat liners 432, 434, 430, the crack will not propagate through to the other valve seat liners in valve seat liner ring assemblies 410.

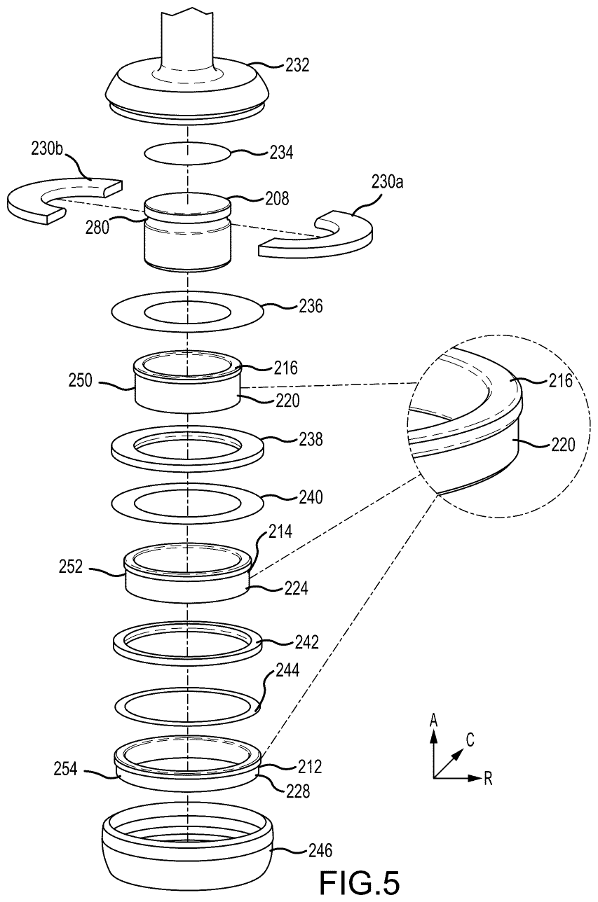

With continued reference to FIG. 2 and FIG. 5, a valve seat and flat plug head configuration 200 is shown in cross section along with an exploded view of a plug head assembly 204.

Plug head assembly 204 comprises a stem 232 that comprises a shaft and disk shaped platform. Stem 232 may comprise various steel alloys, stainless steel, titanium, titanium alloys, and nickel chromium alloys, such as an austenitic nickel-chromium alloy such as the austenitic nickel-chromium alloy sold under the trademark INCONEL. Gasket 234 comprises comprise rubber, silicone, synthetic rubbers, polytetrafluoroethylene (PTFE), glass filled PTFE, expanded PTFE, and other similar materials. Gasket 234 has a higher coefficient of thermal expansion (CTE) than stem 232, gasket 234 will expand at a faster rate than stem 232 in response to increased temperatures.

Plug head 208 is secured by plug head clamp halves 230a and 230b about a groove 280 in plug head 208. Plug head clamp halves 230a and 230b may comprise various steel alloys, stainless steel, titanium, titanium alloys, and nickel chromium alloys, such as an austenitic nickel-chromium alloy such as the austenitic nickel-chromium alloy sold under the trademark INCONEL. By interfacing with the groove 280 in plug head 208, plug head clamp halves 230a and 230b axially retain plug head 208 with stem 232.

In various embodiments, plug head assembly 204 comprises one or more valve plug head liner assemblies, such as plug head liner assemblies 216, 214, and 212. Each of plug head liner assemblies 216, 214, and 212 comprises a plug head liner and a compliant sleeve. In this regard, plug head liner assembly 216 comprises plug head liner 220 and compliant sleeve 250, plug head liner assembly 214 comprises plug head liner 224 and compliant sleeve 252, plug head liner assembly 212 comprises plug head liner 228 and compliant sleeve 254.

Plug head liners 220, 224, 228 can comprise one or more ceramics such as silicon carbide (SiC), boron carbide (B₄C), tungsten carbide (WC), and zirconia (ZrO₂). Plug head liners 220, 224, 228 are generally cylindrical in geometry, having a constant inner diameter (ID), though the inner diameter may taper from axial end to axial end in various embodiments. Plug head liners 220, 224, 228 further include a proximal lip or flange about the outer circumference of plug head liners 220, 224, 228. For example, the proximal portion of the outer diameter of plug head liners 220, 224, 228 may radially protrude. This proximal flange may have a variety of cross sectional profiles, including rounded, square, “bull nose,” or any other suitable geometry.

Compliant sleeves 250, 252, 254 may comprise rubber, silicone, synthetic rubbers, polytetrafluoroethylene (PTFE), glass filled PTFE, expanded PTFE, and other similar materials. Compliant sleeves 250, 252, 254 can comprise rigid or semi-rigid PTFE. In various embodiments, compliant sleeves 250, 252, 254 comprises carbon filled PTFE. Carbon filled PTFE may comprise a mixture of PTFE and a carbon form, for example, carbon powder. Carbon filled PTFE may comprise from 0.2% carbon powder to 40% carbon powder by weight, with the balance of the weight being PTFE. Carbon filled PTFE may comprise PTFE and graphite. Compliant sleeves 250, 252, 254 may thus be elastically deformable.

In various embodiments, a plug head liner is surrounded at least partially about the outer circumferential surface with a compliant sleeve. The compliant sleeve may cover at least a portion of the outer surface of the outer circumference of the plug head liner and may extend in an axial direction. In various embodiments, the compliant sleeve may extend the entirety of the axial length of the plug head liner, though in various embodiments, the compliant sleeve may extend in an axial direction to the outer circumferential flange of the plug head liner. In this manner, the outer circumferential flange of the plug head liner may not be surrounded by the compliant sleeve.

With continued reference to FIG. 5, retention rings 238 and 242 may comprise various steel alloys, stainless steel, titanium. Retention rings 238 and 242 support plug head liner assemblies 212 and 214, respectively. Retention rings 238 and 242 may be coupled to retainer 246 and/or stem 232 such that retention rings 238 and 242 cannot move relative to retainer 246 and/or stem 232. In this manner, retention rings 238 and 242 may contact the outer diameter of plug head liner assemblies 212 and 214. More specifically, retention rings 238 and 242 may contact the flanged portions of plug head liners 224 and 228. Retention rings 238 and 242 may have a counterbore on the inner diameter such that a portion of retention rings 238 and 242 may radially extend to interface with flanged portions of plug head liners 224 and 228. This configuration acts to axially retain plug head liner assemblies 212 and 214. Plug head liner assembly 212 may have a similar interaction with an inner diameter feature of one or more of retainer 246 and/or stem 232. In this manner, one or more of retainer 246 and/or stem 232 may have an area of different radial thickness that interfaces with the flanged portions of plug head liner 228, thus acting to axially retain plug head liner assembly 212 with respect to valve one or more of retainer 246 and/or stem 232.

With momentary reference to FIG. 3, the coupling of retention rings 238 and 242 and one or more of retainer 246 and/or stem 232 with plug head liners 220, 224, 228 is shown by interfaces 316, 318, and 320. Interfaces 316, 318, and 320 comprise the outer diameter flanged feature of plug head liners 220, 224, 228 contacting a counterbore or other radially recessed feature of retention rings 238 and 242 and one or more of retainer 246 and/or stem 232. In this manner, interfaces 316, 318, and 320 provide contact area surfaces for axial retention.

With continued reference to FIG. 5, gaskets 236, 240, and 244 may comprise rubber, silicone, synthetic rubbers, polytetrafluoroethylene (PTFE), glass filled PTFE, expanded PTFE, and other similar materials. Gaskets 236, 240, and 244 can comprise rigid or semi-rigid PTFE. Gaskets 236, 240, and 244 are interspersed in the assembly to axially support plug head liner assemblies 216, 214, and 212. In this manner, expansion of gaskets 236, 240, and 244 impart an axial force onto plug head liner assemblies 216, 214, and 212.

As described and illustrated, plug head liner assemblies 216, 214, and 212 are concentric (coaxial) or substantially concentric, where substantially in this context only means+/−8% of the inner diameter length of at least one of plug head liner assemblies 216, 214, and 212. Moreover, compliant sleeves 250, 252, 254 and gaskets 236, 240, and 244 ensure that plug head liners 220, 224, 228 have no direct, surface to surface contact or minimal direct, surface to surface contact. In this manner, forces (such as impulse forces from high speed fluid flow of corrosive and erosive media and/or media that is of mixed solid and liquid phases) exerted on one of plug head liners 220, 224, 228 are not directly imparted to the other valve seat liners and may be in part mitigated by the presence of compliant sleeves 250, 252, 254 and gaskets 236, 240, and 244. Accordingly, should a crack develop in one of plug head liners 220, 224, 228, the crack will not propagate through to the other valve seat liners in plug head liner assemblies 216, 214, and 212.

Benefits and other advantages have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, and any elements that may cause any benefit or advantage to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C.

Systems, methods and apparatus are provided herein. In the detailed description herein, references to “various embodiments”, “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element is intended to invoke 35 U.S.C. 112(f) unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

1. A valve seat comprising:
a valve seat housing coaxially disposed with a seat liner assembly;
the seat liner assembly comprising a first valve seat liner assembly and a second valve seat liner assembly, the first valve seat liner assembly disposed coaxially to the second first valve seat liner assembly;
wherein the first valve seat liner assembly comprises a first ceramic liner and a first compliant sleeve,
wherein the second valve seat liner assembly comprises a second ceramic liner and a second compliant sleeve.

2. The valve seat of claim 1, wherein the first ceramic liner is disposed coaxially to the first compliant sleeve and wherein the second ceramic liner is disposed coaxially to the second compliant sleeve.

3. The valve seat of claim 2, wherein the first compliant sleeve comprises at least one of expanded PTFE and carbon-filled PTFE.

4. The valve seat of claim 3, wherein the first ceramic liner and the second ceramic liner comprise at least one of silicon carbide (SiC), boron carbide (B₄C), tungsten carbide (WC), and zirconia (ZrO₂).

5. The valve seat of claim 4, further comprising a first retention ring disposed coaxial to the first ceramic liner and a second retention ring disposed coaxial to the second ceramic liner, wherein the first retention ring and the second retention ring comprise titanium.

6. The valve seat of claim 5, wherein first retention ring surrounds and contacts a flanged outer diameter portion of the first ceramic liner.

7. The valve seat of claim 6, wherein the first retention ring includes an inner diameter recess that contacts the flanged outer diameter portion of the first ceramic liner.

8. The valve seat of claim 7, further comprising a gasket disposed proximal to the first ceramic liner.

9. The valve seat of claim 8, further comprising a third valve seat liner assembly disposed coaxial to the first valve seat liner assembly.

10. The valve seat of claim 9, wherein the valve seat housing completely surrounds the seat liner assembly.

11. A plug head assembly comprising:
a stem coupled to a retainer, the retained comprising an annulus geometry;
a plug head liner assembly disposed coaxial to the retainer;
the plug head liner assembly comprising a first plug head liner assembly and a second plug head liner assembly, the first plug head liner assembly disposed coaxially to the second first plug head liner assembly;
wherein the first plug head liner assembly comprises a first ceramic liner and a first compliant sleeve,
wherein the second plug head liner assembly comprises a second ceramic liner and a second compliant sleeve.

12. The plug head assembly of claim 11, wherein the first ceramic liner is disposed coaxially to the first compliant sleeve and wherein the second ceramic liner is disposed coaxially to the second compliant sleeve.

13. The plug head assembly of claim 12, wherein the first compliant sleeve comprises at least one of expanded PTFE and carbon-filled PTFE.

14. The plug head assembly of claim 13, wherein the first ceramic liner and the second ceramic liner comprise at least one of silicon carbide (SiC), boron carbide (B₄C), tungsten carbide (WC), and zirconia (ZrO₂).

15. The plug head assembly of claim 14, further comprising a first retention ring disposed coaxial to the first ceramic liner and a second retention ring disposed coaxial to the second ceramic liner, wherein the first retention ring and the second retention ring comprise titanium.

16. The plug head assembly of claim 15, wherein first retention ring surrounds and contacts a flanged outer diameter portion of the first ceramic liner.

17. The plug head assembly of claim 16, wherein the first retention ring includes an inner diameter recess that contacts the flanged outer diameter portion of the first ceramic liner.

18. The plug head assembly of claim 17, further comprising a gasket disposed proximal to the first ceramic liner.

19. The plug head assembly of claim 18, further comprising a plug head disposed coaxial to the first ceramic liner and the second ceramic liner.

20. The plug head assembly of claim 19, wherein the plug head is axially retained by a plug head clamp.
